(19) United States
(12) Patent Application Publication
(10) Pub. No.: US 2014/0068717 A1
(43) Pub. Date: Mar. 6, 2014

(54) METHOD AND SYSTEM FOR CONTROLLING ACCESS

(71) Applicants: Keith Mayes, Hungerford (GB); Farad Azima, London (GB)

(72) Inventors: Keith Mayes, Hungerford (GB); Farad Azima, London (GB)

(73) Assignee: Nearfield Communications Limited, Buckinghamshire (GB)

(21) Appl. No.: 14/112,335

(22) PCT Filed: Apr. 17, 2012
(86) PCT No.: PCT/GB2012/050843

§ 371 Date: Nov. 15, 2013

(30) Foreign Application Priority Data
Apr. 18, 2011 (GB) 1106516.6

(51) Int. Cl. H04L 29/06; H04W 12/08

(52) U.S. Cl. CPC H04L 63/107; H04W 12/08
USPC 726/3

(57) ABSTRACT

A method and system for controlling access to a service by increasing security and/or authentication is described. A security controller comprises: a processor that receives event data and is connected to a state data store comprising state data indicating a status of a first device in a computing system. The state data comprises a proximity status of the first device relative to at least one other device in the computing system and a security status of the first device relative to at least one other device in said computing system. A policy data store stores a policy determining the required proximity status and security status of the first device. The processor is configured to read the event data, state data and the policy; determine whether the proximity status of the first device meets the required proximity status defined in the policy; determine whether the security status of the first device meets the required security status defined in the policy and output action data via an action output if both said determining steps are complied with.

### TECHNICAL FIELD

The invention relates to a method and system for controlling access to a service by increasing security and/or authentication.

### BACKGROUND ART

It is widely recognised that information security is of growing importance in the light of increasing reliance on secure ICT by government, business and individuals. Because of sophisticated security attacks, the emphasis on secure authentication for legitimate access has increased greatly. The strength of authentication relating to users is affected by the number of “factors” that are used. Classically the different classes of factors are defined as “something you know” (e.g. PIN/password), “something you have” (smart card, key fob) and “something you are” (biometric).

Adding more factors of different class can increase security. Adding additional factors of the same class can also increase security and reliability, especially in the case of biometrics e.g. read multiple fingerprints instead of one. However, these added steps make the overall process complex, slow, intrusive and prone to errors; such that users avoid such systems when they can. Another example is the credit card industry in the UK. The Chip (something you have) and PIN (something you know) solution has been successful at reducing fraud, but banks are now promoting touch and pay transactions (no PIN) to offer more customer convenience. This strategy reduces security but increased transactions/usage may offset fraud losses, however for many services a significant reduction in security cannot be tolerated.

Some examples of known systems include US 2005/0221798 which describes a method of controlling access to a device in a wireless system using proximity based authentication. US 2009/0210940 describes a system and method of granting and removing a user's security access to applications on a computer using proximity of authorised RFID tags. US 2006/0252411 describes a proximity based security protocol for processors based systems. If a response is not received from a device normally carried by a user, it may be determined that the user is not sufficiently proximate to the device being accessed and that, therefore, the person accessing the device is not authorised.

US2011/0034160 describes a trusted service manager (TSM) that manages reports of lost or stolen mobile communication devices. When a customer realises that his mobile communications device has been lost or stolen he sends a report to a mobile network operator (MNO). The MNO communicates with the TSM and appropriate action is taken.

### STATEMENTS OF INVENTION

According to a first aspect of the invention there is provided a security controller for controlling at least one of a plurality of interconnectable devices, the security controller comprising:
an event input to receive event data;
an action output to output action data;
a processor coupled to said event input to receive said event data,
wherein said processor is connected to a state data store comprising state data indicating a status of a first device in said computing system, said state data comprising a proximity status of said first device relative to at least one other device in said computing system and a security status of said first device relative to at least one other device in said computing system; and
wherein said processor is connected to a policy data store comprising a policy determining the required proximity status and security status of said first device, wherein said required proximity status defines a proximity connection requirement between said first device and at least one other device and wherein said required security status defines a security connection requirement between said first device and at least one other device,
wherein said processor is configured to
read said event data, state data and said policy;
determine whether said proximity status of said first device meets the required proximity status defined in said policy;
determine whether said security status of said first device meets the required security status defined in said policy and
output action data via said action output if both said determining steps are complied with.

This invention seeks to use the fact that users have multiple personal devices that are unlikely to be used within a given proximity arrangement without the legitimate user's co-operation.

An event received via the event data input may signal establishing or a loss of proximity, a timer, a user request, or a system request for example. The state stored in the state data store, in conjunction with the policy, then defines what action is taken and what the new state will be. This new state may then be stored within the state data store.

Action data may be output via the action output responsive to meeting proximity and security requirements and thus, the security controller may be configured to move through multiple different internal states before access/functionality is enabled.

Action data may be direct functions that invoke operations in the first device, e.g. to permit or deny access to a service offered on said first device or another device (which may be remote and accessible via the first device for example). The action data may alternatively invoke a change of state in the first device, e.g. in response to the event input. Alternatively, the action data may affect the security controller itself.

The processor may be connected to a weights store storing weights which may affect actions, changes of state and the like. These weights may be adapted and/or updated as part of a learning process within the security controller. The learning process may use the event data and action data output to devices as a source of data for learning. Similarly, the processor may be configured to adapt/update the policy stored in the policy store, e.g. as part of a learning algorithm.

Said proximity connection requirement may comprise a physical connection requirement or a wireless connection requirement between said first device and at least one other device. In either case, the connection enables communication between devices. The wireless connection requirement between said first device and at least one other device; said wireless connection enabling communication between said first device and said at least one other device. Said processor may be configured to determine whether said proximity connection requirement between said first device and at least one other device is met automatically. Automated proximity determination is possible as many modern and personal devices have wireless interfaces e.g. NFC phones, laptops, RFIDs, Bluetooth devices, contactless smart cards, passports, key fobs, WLAN access points etc. In operation the user simply needs to ensure that the devices satisfy the proximity policy requirements throughout the protected session.

With a wireless connection, the proximity connection requirement may be one of determining a minimum wireless signal strength or a maximum distance between said first device and said at least one other device. Alternatively it may be sufficient to detect the presence of the necessary connection.

Said processor may be configured to output action data comprising data enabling or disabling access to a service. The user is thus protected against inadvertently leaving an unsupervised enabled session by disabling access, as the removal of a personal device (e.g. phone) will tear down the session. Intelligent processing can also be used to tear-down (as well as set-up) to give the user a chance to restore an accidentally lost proximity connection e.g. smart card dropped on floor. Herein, when we refer to service, we include applications, data, and functionality. Thus when access to a service is disabled, a service may be a portion of functionality whereby other functionality, albeit limited, may be maintained when access is disabled.

The service may be hosted remotely to the first device and the at least one other device, on a remote server for example.

Where the processor determines that the security connection requirement is not met but the proximity connection requirement is met, the processor may be configured to output action data via said action output, said action data initiating said security connection requirement between said first device and said at least one other device to be established.

A security solution is possible as many modern and personal devices increasingly have protected security areas, elements, chips or software intended for the safe storage of sensitive credentials and execution of security algorithms and protocols. Furthermore such devices are typically capable of hosting programs that can intelligently and adaptively manage proximity linkage, security connections and associated privileges and actions.

Accordingly, the security connection requirement may comprise establishing an authenticated connection between said first device and at least one other device. Said processor may be connected to at least one credential data store comprising security credentials for one or more of said plurality of devices, wherein said security credentials are used to establish authentication connections between devices.

Said policy data store, said state data store and said security controller may be integrated in said first device. Similarly said credential data store storing credentials for said first device may be integrated in said first device. Alternatively, said policy data store and/or said credential data store may be managed by another device, e.g. a trusted service manager.

The computer system may comprise at least two devices. Where there are only two devices, the policy may define said proximity connection requirement as between said first device and a second device and said security connection requirement as also between said first device and said second device. Where there are more than two devices, the policy may define said proximity connection requirement as between said first device and a second device and said security connection requirement as between said first device and a third device.

According to another aspect of the invention, there is provided a device comprising a security controller as described above. The device may be any personal computing device, e.g. a computer, laptop, mobile phone, PDA, smart card, RFID module etc.

According to another aspect of the invention, there is provided a computer system comprising a plurality of interconnectable devices wherein at least one device comprises a security controller. Some or all of the interconnectable devices may comprise a security controller.

The system may comprise a first device comprising a security controller as described above; a second device hosting a service which is accessible from said first device, and a third device, wherein said policy accessed by said security controller on said first device defines a proximity connection requirement and a security connection requirement between said first device and said second device and a proximity connection requirement and a security connection requirement between said first device and said third device and
wherein said processor is configured to
determine whether said proximity status of said first device satisfies the proximity connection requirement with both said second and said third devices;
determine whether said security status of said first device satisfies the security connection requirement with both said second and said third devices and
output action data via said action output, said action data enabling access to said service if both said determining steps are complied with

Where both determining steps are not met, said processor may be configured to output action data via said action output, said action data initiating said security connection requirement between said first device and said third device to be established if said processor determines said proximity status but not said security status is met. Said processor may also be configured to output action data via said action output, said action data enabling said security connection requirement between said first device and said second device to be established if said processor determines said proximity status but not said security status between said first and second devices is met and if said processor determines said proximity and security status of said first and third devices is met.

In other words, establishing a secure connection between said first and said second devices is dependent on establishing a secure connection between said first and said third devices. In the case that each device is connected to (or integrated) with a credential store storing security credentials for that device, this may be achieved by establishing said authenticated connection between said first and second devices using some or all of the credentials from said third device as well as some or all of the credentials from said second device.

The computing system may further comprise a fourth device. Said policy accessed by said security controller on said first device may define a proximity connection requirement and a security connection requirement between said first device and said second device, a proximity connection requirement and a security connection requirement between said first device and said third device and a proximity connection requirement and a security connection requirement between said first device and said fourth device. As with the system having three devices, establishing a secure connection between said first and said second devices is dependent on establishing a secure connection between said first and said third devices together with establishing a secure connection between said first and said fourth devices. In the case that each device is connected to (or integrated) with a credential store storing security credentials for that device, this may be achieved by establishing said authenticated connection between said first and second devices using some or all of the credentials from said third and fourth devices as well as some or all of the credentials from said second device. It will be appreciated that the system can be expanded to define policies having more than four devices

In other words, by using multiple devices, one or more may operate in a transparent mode such that if a device (a mobile phone for example) is unable to meet one or more the proximity/security requirements then that particular device may meet these requirements within another device (such as a smart card). By virtue of the mobile phone and smart card meeting the necessary requirements, the mobile phone may then, in effect, operate in a transparent mode whereby the authentication necessary is provided by the smart card, via the mobile phone, back to a computer for example.

Multiple proximity connections may also be used between different devices or between the same devices. For example, a service may mandate both an NFC wireless proximity connection requirement and also a WLAN proximity connection requirement to a device requesting access to the service. The use of multiple proximity connections increases the confidence level on which the decision to authenticate is based.

Said third device may also comprise a security controller as described above. In this case, said policy accessed by said security controller of said third device may define a proximity connection requirement and a security connection requirement between said third device and said fourth device. Said processor of said security controller of said third device may be configured to determine whether said proximity status of said third device satisfies the proximity connection requirement with said fourth device; determine whether said security status of said third device satisfies the security connection requirement with said fourth device and output action data via said action output, said action data enabling said security connection requirement between said first device and said third device to be established if said processor determines both said determining steps are met.

In other words, said secure connection between said first and third devices is dependent on first establishing a secure connection between said third and fourth devices. As previously described, said processor of said third device may output action data enabling said security connection requirement between said fourth device and said third device to be established if said processor determines said proximity status but not said security status is met.

In the computing system the plurality of interconnected devices may be arranged into a layered hierarchy. Each of the plurality of interconnectable devices may then be assignable to one of the layers.

In a first layer in the computing system a layer one interconnectable device (a device assigned to layer one) may be capable of accessing the service. The service may be hosted by the same device or may be hosted on another device.

In a second layer, a layer two interconnectable device may be capable of satisfying a proximity connection requirement and a security connection requirement to the layer one interconnectable device so that the layer one interconnectable device may access the service. Accordingly there may need to be devices assigned to at least two layers in order for access to a service to be permitted.

In the computing system the service may be hosted on a third layer by a third device, or the service may also be hosted by the first device so that the first device can access one of its own services once the proximity connection and security connection requirements are met.

Furthermore, one or more of the interconnectable devices may be assignable to one or more layers, in other words, a device may reside in multiple layers, either at different times (whereby a device is only assigned to one layer at a time), or simultaneously whereby it is assigned to multiple layers at the same time. For example one device may host a service and also be capable of satisfying a proximity connection requirement and/or security requirement to a layer one interconnectable device.

The assignment of one or more interconnectable devices to one or more of the layers may be dependent on context credentials of the one or more interconnectable devices. The context credentials may comprise one or more of capabilities of the device or be dependent on the particular context of the device.

In other words, the context credentials may define the capabilities of a device and what features it may provide, which may vary over time. A device may be moveable between layers dependent on its capabilities, for example, if a device may be updated to provide new services or may be upgraded to provide a new adapter providing different wireless receivers (and thus, new proximity connection capabilities).

Device context may be related to time, location or duration of use for example, although it will be appreciated may other variables (or combinations of variables) may be used to specify the context of a device. Thus, the usage model of a device may change. In other words, a device may be configured to support one or more services, as selected by a provider of the services; it may also be configured to only be used in certain contexts, such as a company office location or at an employee's home, but nowhere else. It may also control the times as which certain services are accessible, and this may vary from service to service. A device, such as a smartphone for example, might be permitted to use some services, such as email at any time (subject to proximity and security requirements imposed). Access to another service, such as access to company files may be restricted to certain hours in the day (again also subject to subject to any proximity and security requirements imposed).

The policy, specifying the required proximity status and security status, may also specify a layer requirement for the one or more interconnectable devices. This may require a device to be present on a specific layer or specify other requirements such as not changing layer within a specified time or duration within a layer. It will be appreciated however that other conditions dependent on layers may also be imposed.

According to another aspect of the invention there is provided a method of controlling access to a service on a first device in a computing system, the computing system comprising a plurality of interconnectable devices, the method comprising: reading access credentials for said service in said computing system, said access policy comprising proximity credentials and security credentials for enabling access to said service on said first device, wherein said proximity credentials define a required proximity status between said first device and at least one other device to enable access to said service on said first device, and wherein said security credentials define a required security status between said first device and at least one other device; determining whether said proximity status of said first device complies with said proximity credentials; determining whether said security status of said first device complies with said security credentials; and enabling access to said service if both of said determining steps are complied with.

The service may be hosted on a second device which is accessible from said first device such that said first device remotely accesses the service.

The proximity credentials defining a required proximity status between said first device and at least one other device may define a required proximity status between said first device and a third device.

In other words, a service hosted on a second device, and accessed by a first device may require that the first device adheres to proximity credentials requiring a third device, such as an RFID tag, mobile phone or the like, to be within a desired proximity of the first device (which may be a laptop computer for example) accessing the service.

In variants this service may be a remote service, operating, for example, as a cloud based service for example. This service may be accessed by the first device and may manage that the first device adheres to proximity credentials requiring a third device, such as an RFID tag or mobile phone to be within a desired proximity of the first device accessing the service.

According to a still further aspect of the invention there is provided a method of controlling access to a service on a first device provided by a remote device in a computing system, the computing system comprising a plurality of interconnectable devices, the method comprising: reading an access policy for said service in said computing system, said access policy comprising proximity credentials and security credentials for enabling access to said service on said first device, wherein said proximity credentials define a required proximity status between said first device and at least one other device to enable access to said service on said first device, and wherein said security credentials define a required security status between said first device and at least one other device; determining whether said proximity status of said first device complies with said proximity credentials; determining whether said security status of said first device complies with said security credentials; and enabling access to said service if both of said determining steps are complied with.

In other words, the service may be accessed by the first device (e.g. a computer) but hosted remotely, for example, on a cloud computing platform. The access policy for the service may mandate certainly proximity credentials (e.g. an RFID tag must be present—other options are specified, by way of example only, throughout the specification) and security credentials (e.g. IDs, cryptographic keys—other options are specified, by way of example only, throughout the specification) before the service can be accessed.

In this, and with other aspects, “proximity” may mean physical separation (but may not necessarily be the only case)—this may also be radio proximity. For example in detecting WLAN and Cell APs we normally know if it is a strong signal or not and the “closest/best” signal may not be from the nearest transmitter (critically depends on whether line of sight or obstructed etc)—i.e. proximity may not be due to measured distance, but another measure that suggests “closeness”. We may also have “closeness” to one AP more than another at the same distance and signal strength, because the former allows us access (satisfies a relationship/security access protocol) and the latter does not. In variants where the service is hosted remotely, the concept of physical distance may be lost, however the notion of “closeness” is relevant e.g. if a few entities are communicating in or via the cloud and they have some “closeness” (they may all registered as part of a particular closed group of devices for example) meaning that some access/control is possible.

Features of other aspects of the invention may also be combined with this aspect.

The invention further provides processor control code to implement the above-described methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

### BRIEF DESCRIPTION OF DRAWINGS

The invention is diagrammatically illustrated, with reference to the following drawings:

FIG. 1 is a schematic representation of an example network of communicating nodes grouped into peer groups;

FIG. 2 is a schematic representation of a node in the network of FIG. 1 which acts as a controller;

FIG. 3 shows the states and transitions between states for the controller of FIG. 2;

FIG. 4 is a schematic representation of the network of FIG. 1 with nodes replaced with devices; and

FIGS. 5a to 5f show flowcharts of the interactions between the devices in various case examples based on FIG. 4.

### DETAILED DESCRIPTION OF DRAWINGS

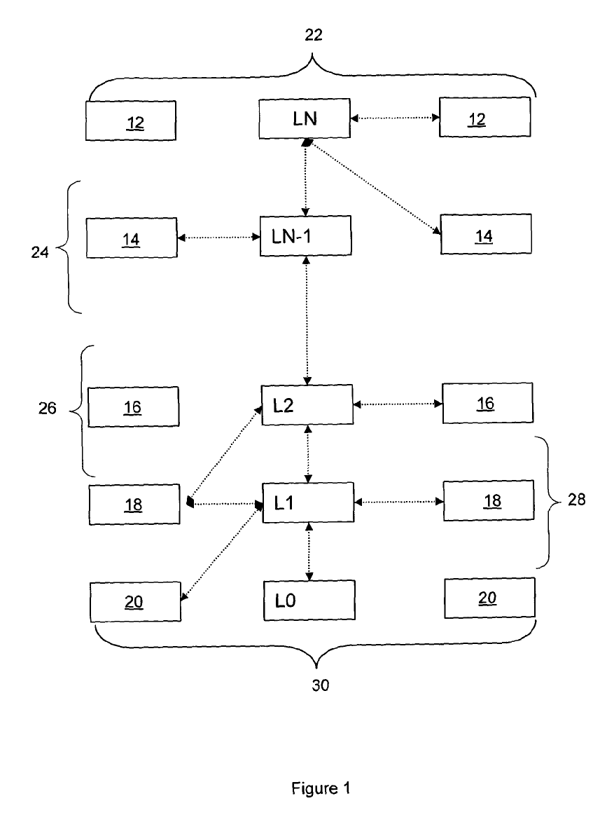

As shown in FIG. 1, the system comprises a plurality of communicating nodes (12, 14, 16, 18, 20) in which the ability to communicate and access services is dependent on the proximity of nodes as well as stored security credentials. Each node has at least one wireless interface that may be used to determine proximity. Proximity is defined as the ability to communicate within the designed range or within a predefined range limit within the maximum range of the wireless interface. Interface examples include:

Short range: Infra Red, NFC, RFID, ANT, W.I.N.D

Medium range Bluetooth, WLAN, Zigbee

Long range: Cellular

The proximity requirements may also use a physical connection between two or more of the communicating nodes, either additionally or alternatively to a wireless connection. This could be via any commonly used form of wired interface, such as USB or the like. This could be a general storage device providing the appropriate proximity and/or security enabling software, or could alternatively be a dedicated proximity/security device.

At any point in time the nodes are arranged in a hierarchy of layers or peer groups (PG) depending on their current credentials (context credentials). A node's credentials may change (e.g. based on service requirements, an algorithm, time, context or external control), altering its peer group membership. Each peer group (22, 24, 26, 28, 30) contains at least two nodes arranged in a minimum of two layers.

The highest level peer group for a given temporal configuration is referred to as the service gateway node (LN) (wherein a service includes data, functionality as previously mentioned). As shown in FIG. 1, the highest lever peer group 22 comprises three nodes 12. This is conceptually a wireless connection to all relevant servers, applications and functionality. In practice it could be a combination of a wireless access point with a broadband connection to servers on the Internet, or an access point to some local fixed wired server equipment and applications, or simply a node which hosts or controls services, data or functionality. In other variants this service node may be remote, provided by a cloud computing platform for example.

The lowest peer group 30 also comprises three nodes 20 referred to as the nodes (L0). For simplicity, three further peer groups are shown, namely the next two lowest peer groups 28, 26 with nodes L1 and L2 and the next highest peer group 24 with nodes LN-1. It will be appreciated that there could be any number of peer groups.

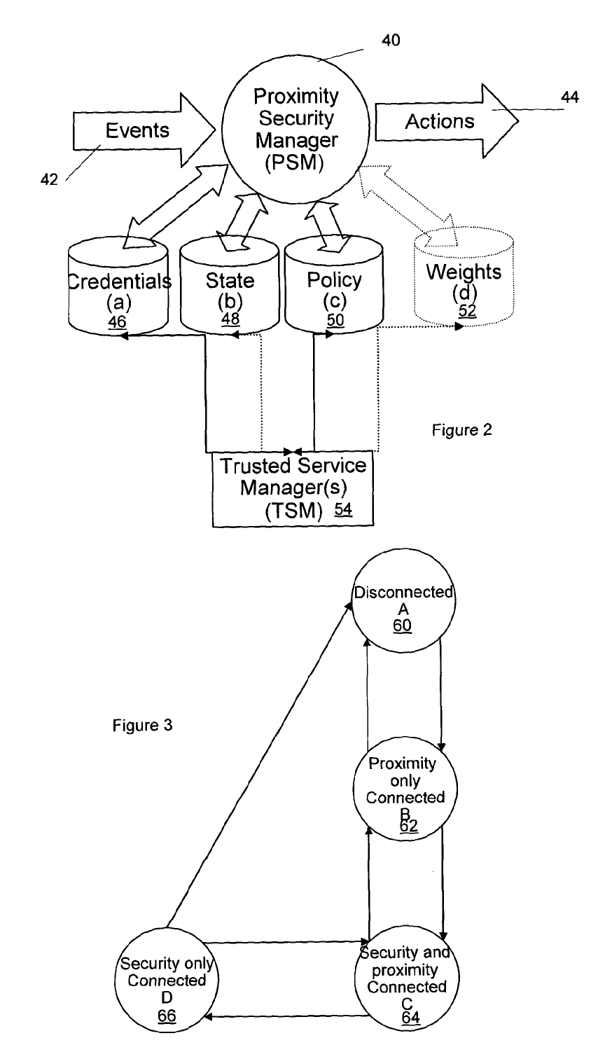

At least one node shown in FIG. 1 must support all or part of the functionality of the node proximity intelligent security controller which is shown in more detail in FIG. 2. It represents a security sensitive mechanism that may be implemented in hardware or software. Specialist hardware is recommended for at least part of the implementation due to attack resistance qualities.

The controller comprises a processor termed a Proximity Security Manager (PSM) 40. The proximity security manager 40 is the functional processor that carries out actions 44 in response to input events 42, based on the current state and policy. It is responsible for using the credentials and associated algorithms and protocols to carry out authentications and establish security connections. The PSM 40 is connected to a number of logical data stores (credential store 46, state store 48, policy 50). Each data store may map to one or more physical stores.

The credential store 46 contains security credentials including IDs, cryptographic keys, and privileges. The state store 48 stores the security state of the controller as described in more detail with reference to FIG. 3. The policy store 50 stores the policy i.e. the state dependent actions to be taken by the controller in response to events. There may also be an optional weight store 52 which stores weights which may modify the effect of the policy. The weight store 52 is shown for clarity as a separate store but may actually be integrated within the policy store.

The weights may be updated as part of a local intelligent learning process or managed by a trusted party. Accordingly, the system may further comprise a trusted service manager 54 which is connected to some or all of the stores. In particular, in the case of trusted management there may be no need to store the weights locally, but simply to revise the current local policy based on intelligent processing in or via the trusted service manager 54. The trusted service manager 54 may be a single device or a plurality of interconnected devices working together to provide the desired functionality.

The trusted service manager 54 is connected to the credential store 46 and is configured to perform the initial personalisation and on-going management of the credentials. The trusted service manager 54 is connected to the policy store 50 and is configured to perform the initial set-up and on-going management of the policy. The trusted service manager 54 is optionally connected to the weight store 52 and may be configured to perform the set-up and on-going management of the local weights. The trusted service manager 54 is optionally connected to the state store 48 and may be configured to perform the set-up, monitoring and supervision of the local state.

The controller exists in a number of distinct states. An example of a plurality of states is shown in FIG. 3 in which there are four states: disconnected 60, proximity only connected 62, security and proximity connected and security only connected 66. Each node may have multiple proximity and security connections. Accordingly, FIG. 3 represents a single instance of the states and transitions.

The policy implemented by the system will define which actions are permitted within each state. For example, in disconnected state 60, only actions that are authorised by the local node credentials alone without the need for a proximity connection are permitted.

In proximity only connected state 62, the following actions may be permitted:
Actions that are sufficiently authorised by the combined local node credentials and the proximity connection(s).
Actions that permit the establishment of a security connection between the local node and a directly connected proximity device.
Actions involving data transfer between the local node and a directly connected proximity device.
Actions in which the local node facilitates two proximity connected devices to establish a security connection between them.
Actions that provide the local node with a temporary security credential (TSC) from directly connected proximity devices.
Actions that use the TSC to allow the local node to access or protect data or services (which includes data and functionality as previously discussed)
Actions that permit service (including data/functionality) access and usage between proximity connected devices.
Actions that calculate and update policy weights.

In security and proximity connected state 64 the following actions may be permitted:
All of the actions in the previous state and:
Actions that involve protected data transfer between security connected endpoints.
Actions that permit secure service access and usage between security connected endpoints.
Actions that will terminate a security connection.
Actions that will respond to the state of reliant proximity connections.
Actions that calculate and update policy weights.
Actions that support remote management via trusted services manager(s).

In security only connected state 66, the following actions may be permitted:
Actions that involve protected data transfer between security connected endpoints that do not rely on the lost proximity connection(s).
Actions that can re-establish lost proximity connection(s).
Actions that decide if and when to terminate a security connection.
Actions that calculate and update policy weight.

FIG. 3 also shows the paths between states and the paths are associated with events and actions. The state transitions and example events which initiate the transitions are described below (for simplicity the on-going low-level monitoring of the multiple instances of proximity connection status is not shown in FIG. 3 or the described actions, but should be assumed):

(1) The system may move from disconnected state 60 to proximity only connected state 62 by bringing two nodes within physical range of their proximity wireless interfaces. The action is that a bearer connection is established. Alternatively, the nodes may already be in range and a user or node control initiates the action.

(2) The system may move from proximity only connected state 62 to security and proximity connected state 64 by a security trigger event. This trigger event may be automatic or user initiated depending on the policy defined in the policy store. The action is that the authentication protocol is successfully executed between two system end-points using the security credentials of the controller(s) (i.e. NPISC(s)).

(3) The system may move from security and proximity connected state 64 back to proximity only connected state 62 by a first disconnect security trigger event. This trigger event may be automatic, policy (of any connected party) initiated, time-out or user interaction. The action is that the security connection is terminated.

(4) The system may move from security and proximity connected state 64 to security only connected state 66 or from proximity only connected state 62 back to disconnected state by a disconnect proximity trigger event. The event can be excessive physical separation, initiated by policy, or user interaction. In the case of a physical dongle, this may also be loss of the physical connection between a computer and the dongle. The action is that the proximity bearer connection is lost—any connections still associated with the state instances are terminated. Loss of proximity does not necessarily automatically end a “session”, but there could be a time-out/warning indicating that the session would be terminated without the proximity requirements being met within a defined timescale.

(5) The system may move from security only connected state 66 to disconnected state 60 by a second disconnect security trigger event. The first and second disconnect security events may be the same and may be triggered by policy (of any connected party), time-out or user interaction. The action is that the security connection is terminated.

The system also may provide alerts to the security connected parties, e.g. following

(a) The event that the proximity connection is lost, for example due to excessive physical separation. The action could be to alert the security connected parties.

(b) The event is the re-establishment of the proximity connection. The policy action could be to alert the security connected parties.

Note that the process to determine the continued presence of the proximity link is determined by policy and could for example require polling at regular intervals.

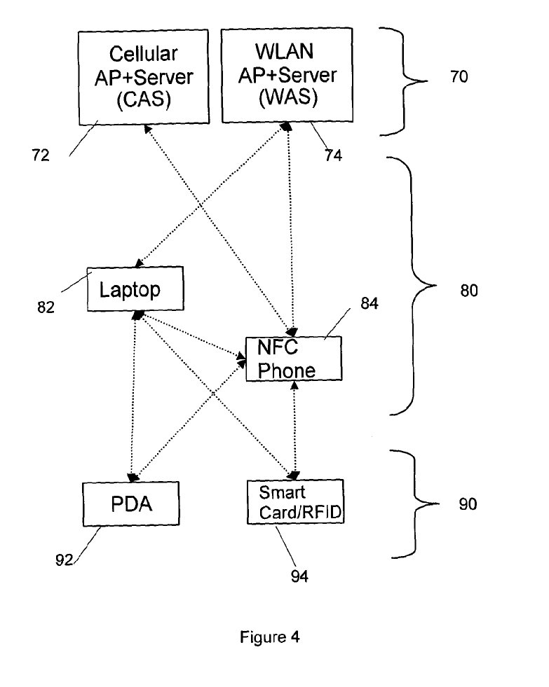

FIG. 4 shows a nodal network similar to that of FIG. 1 comprising a plurality of interconnectable devices. The nodal network may comprise some or all of the depicted devices which may be categorised as a service gateway node 70, a normal node 80 or a lowest level node 90. The service gateway node 70 may be a cellular access point combined with a server (termed CAS) 72 or a wireless local area network (WLAN) access point combined with a server (termed WAS) 74. Such gateway nodes are the highest level nodes within the network and represent the node offering services (It should be noted that this is just an example and the service/functionality gateway node could equally well have been shown as the laptop, phone, PDA or smart card, or a remote service/device. It is assumed that the CAS has only a cellular proximity interface and that the WAS has only a WLAN proximity interface.

The normal nodes may be any one of a laptop 82, a near field communication (NFC) phone 84 or a similar device. It is assumed that all such devices provide a plurality of proximity interfaces, e.g. WLAN, NFC, Bluetooth etc. The lowest level nodes may be any one of a personal data assistant (PDA) 92, a smart card/RFID tag 94 or similar device. It is assumed that each such device has only one proximity interface, e.g. the PDA has only a Bluetooth proximity interface, the smart card/RFID have an NFC/contactless interface.

It will be appreciated that some devices operate in the far-field where the electric field dominates. This includes Bluetooth, GSM, WLAN for example. In addition, some RFID systems operate at UHF frequency ranges (900 MHz range) and would still be considered far-field devices. (note that when we herein refer to smart card, we use this to imply smart cards, RFIDs, security tokens, tags, card/RFID emulators (e.g. NFC phones), passive and active types using wireless, contactless and contact interfaces and the like).

Other devices may operate in the near field where the magnetic field dominates. An example of near field devices includes RFID system operating at low bands, such as 13.56 MHz.

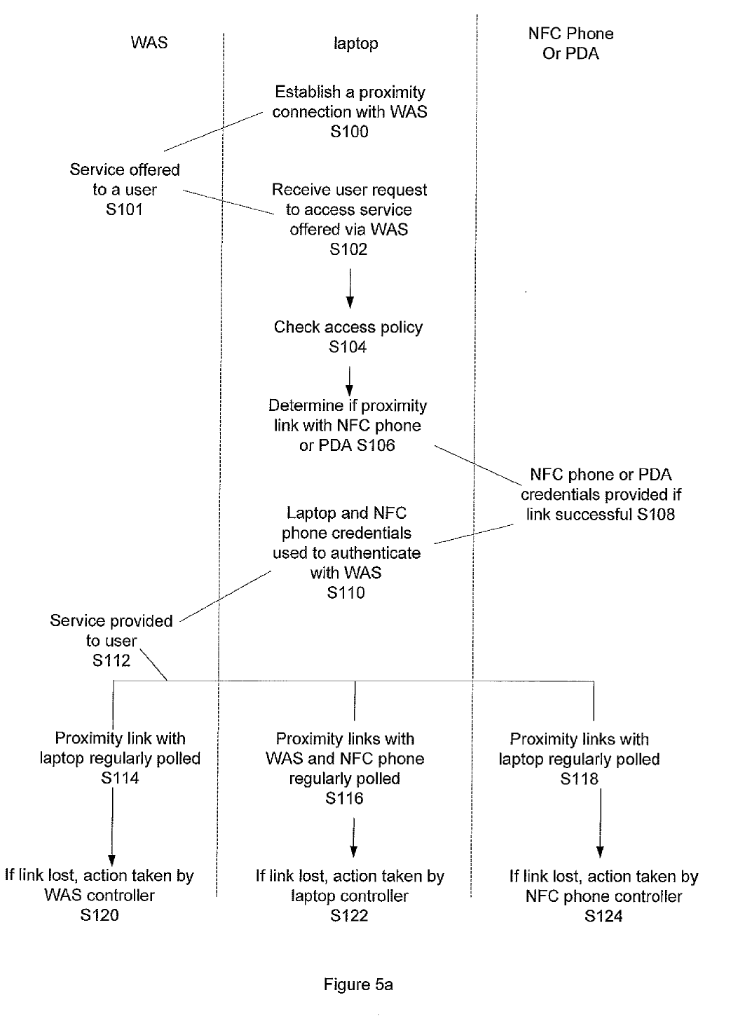

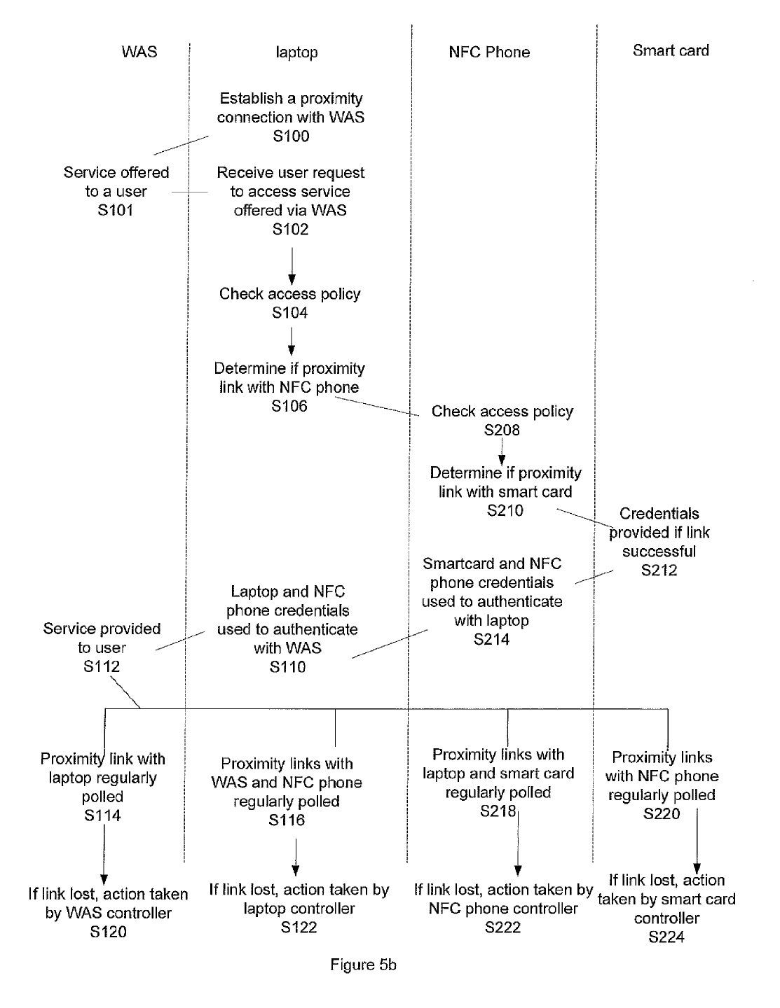

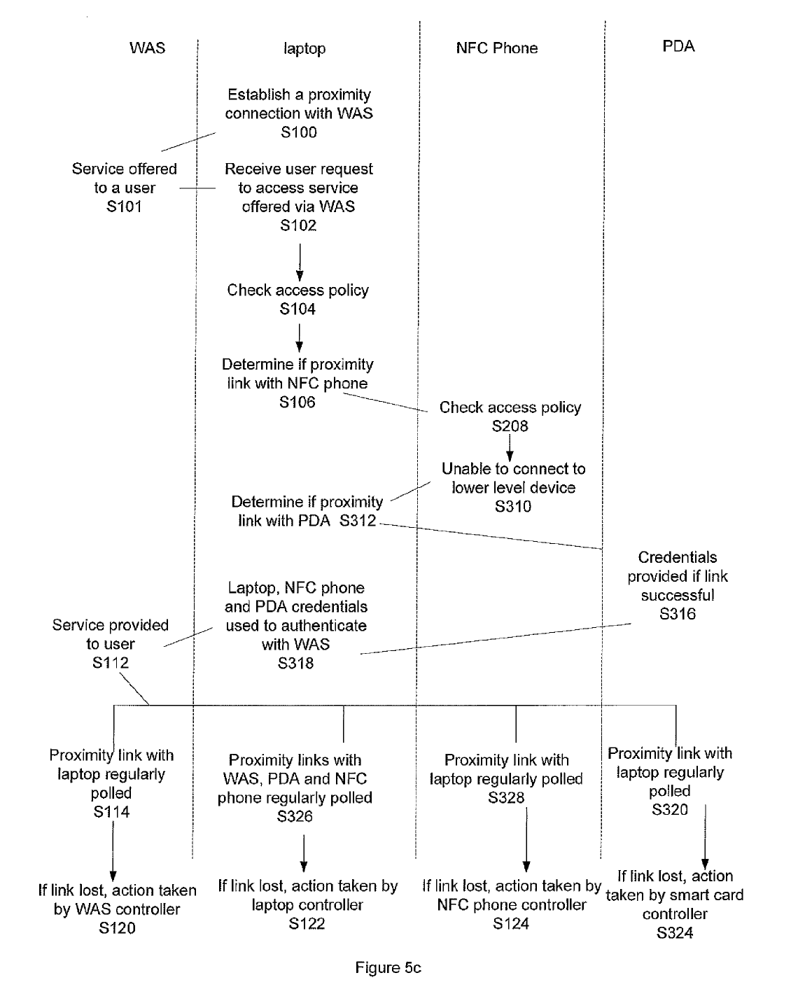

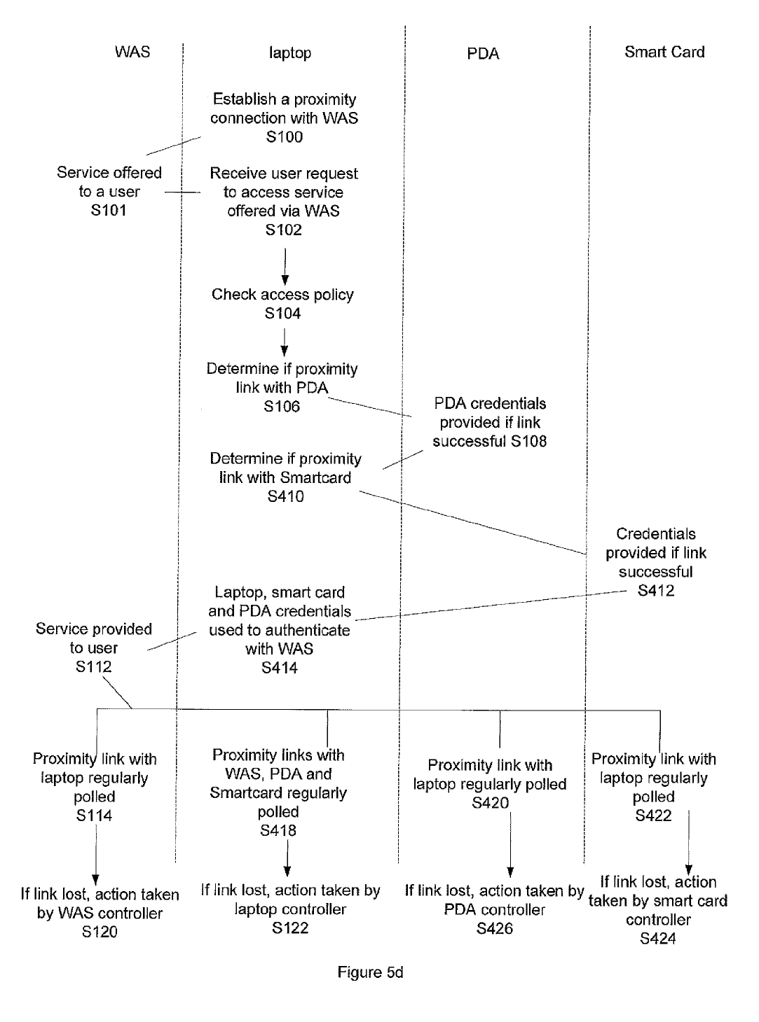

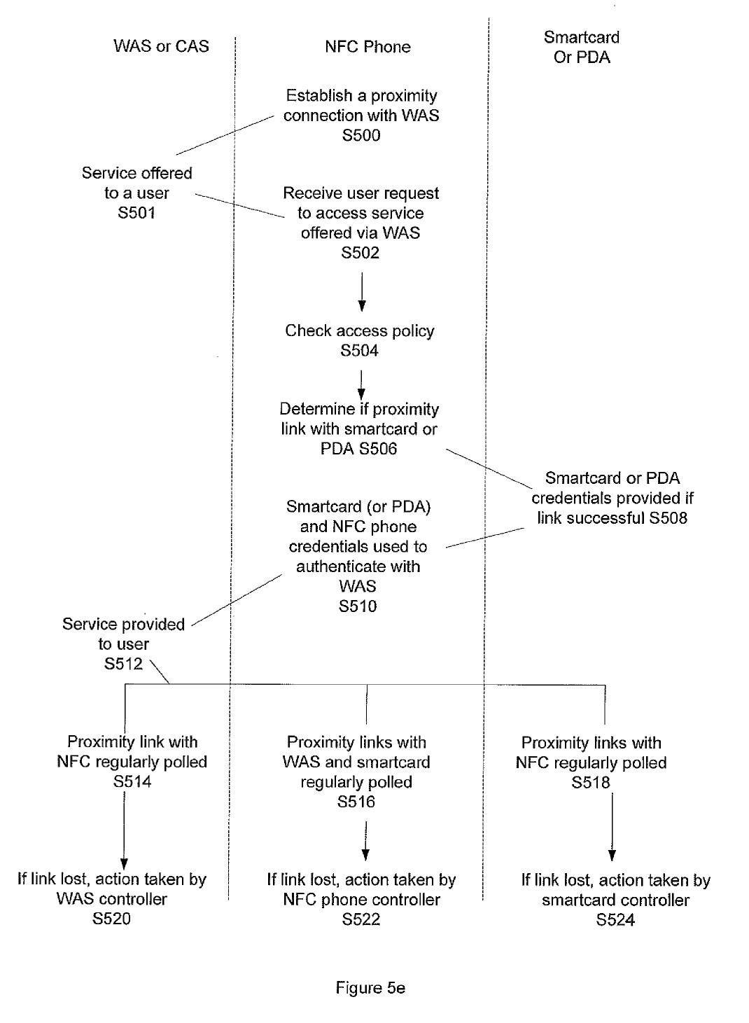

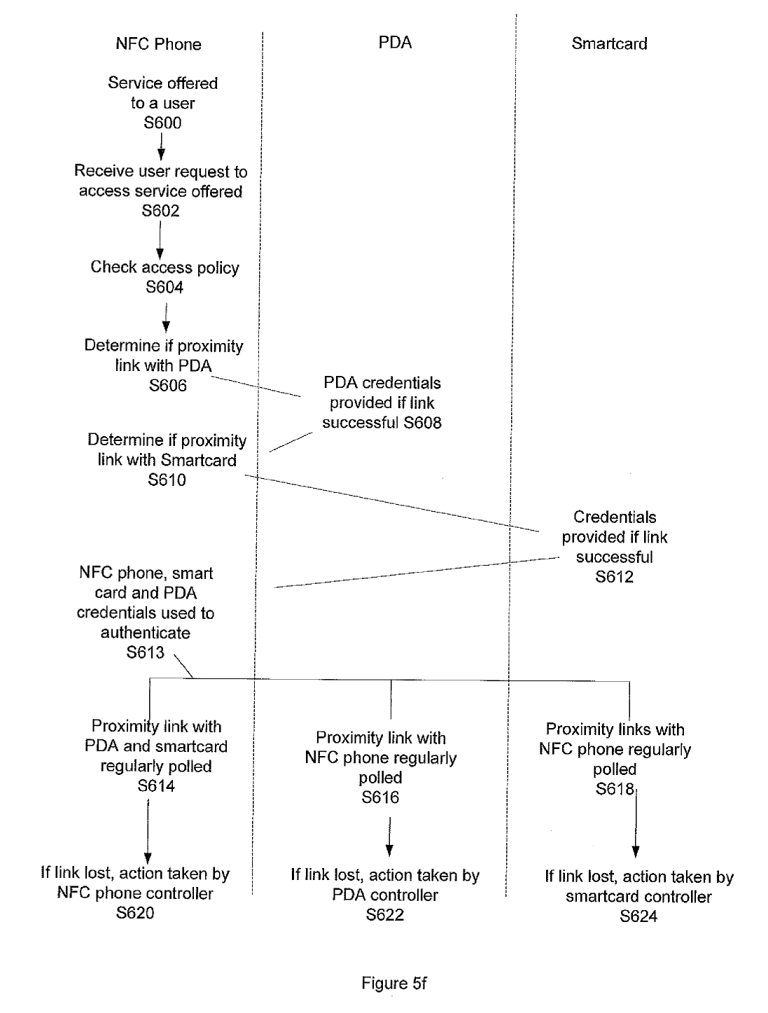

FIG. 5a shows the steps for a first case example comprising a three layer network having a WAS at the highest level (L2) (herein also referred to as layer three), a laptop at level 1 (herein also referred to as layer one) and either an NFC phone or PDA at the lowest level (L0) (herein also referred to as layer two). The first step (S100) is for the laptop controller to determine whether or not there is an established proximity connection with the WAS. This could be done automatically by bringing the laptop controller within the predetermined connection range of the WAS or by control or user interaction once the two devices are within connection range. The second step is for a service supported by the WAS to be offered to a user (Step S101). The user wishes to access a service offered via the WAS and a request is received at the laptop (step S102).

At the next step (step S104), the laptop controller (NPISC) checks the access policy to the service. The laptop controller determines that access to the service requires authentication to establish a security connection between the two devices.

Furthermore, the access policy (in conjunction with the service information) states that an authentication result based on only the laptop's credentials alone is not sufficient and that at least one proximity connection is required to a node in a lower level peer group. Accordingly, at the next step S106, the laptop's NPISC attempts to establish (or checks if already established) a proximity link with the NFC phone (or the PDA).

As shown at step S108, if the proximity link is successfully established then a security connection (i.e. service authentication) is completed between the laptop and NFC phone. The NFC credentials are provided to the laptop. As shown at step S110, the laptop uses all or a sub-set of its own credentials and the result (i.e. credentials) from the NFC phone to successfully authenticate with the WAS. The laptop then has two proximity and security connections, i.e. with the NFC phone (or PDA) and WAS. The NFC phone (or PDA) and WAS each have a single proximity and security connection. As shown, at step S112, the user his given access to the service. While the user has access, the existence of the proximity links is regularly polled. The proximity links may be polled by the laptop controller only (step S116). Alternatively, the WAS controller and/or the NFC phone (or PDA) may also regularly poll the links (steps 114, 118). If a proximity link is lost, an action is taken based on the policies of the controllers (steps S120, S122 and S124. The action can range from do nothing, wait, tear down session, try to re-establish etc. At the end of a successful session the connections will be torn down.

FIG. 5b shows the steps for a second case example comprising a four layer network having a WAS at the highest level (L3), a laptop at level 2, an NFC phone at level 1 and a smart card at the lowest level (L0). Steps S100 to S106 are the same as FIG. 5a and thus the same number is used. At step S208, the NFC phone's controller (NPISC) policy discovers that it cannot satisfy the authentication with the NFC credentials alone and requires a connection to an L0 device. It will be appreciated, the step S208 may also be carried out by the laptop's controller.

At step S210, the NFC phone NPISC attempts to establish (or checks if already established) a proximity link with the smart card. At step S212, if the proximity link is successful then a security link (i.e. service authentication) is completed between the NFC phone and the smart card providing a result based on the smart card credentials. The NFC phone uses all or a sub-set of its own credentials and the results from the smart card to successfully authenticate (i.e. establish a security connection) to the laptop (step S214). The laptop and the NFC phone each have two proximity and security connections and the smart card and WAS each have one proximity and security connection.

Steps S110 to S116 are the same as FIG. 5a. Additionally, the NFC phone and smart card may also poll the links (steps S218, S200). Action may be taken by any or all of the devices if any links are lost (steps S120,S122,S222 and S224).

In a variation of the arrangement of FIG. 5b, the NFC phone may operate in transparent mode. In this case, the NFC phone does not establish a security connection with the laptop but facilitates a security connection between the smartcard and laptop. Thus, the NFC phone is acting as a transparent pipe. The laptop and the NFC phone each have two proximity connections (i.e. laptop with NFC phone and WAS; NFC phone with laptop and smartcard. The smart card and WAS each have one proximity and security connection. The smartcard has a proximity connection with the NFC phone and a security connection with the laptop. The WAS has a proximity and security connection with the laptop. Thus the laptop has two security connections, one with the smart card and one with the WAS. The NFC phone has no security connections. In this variation, not all proximity connections are also security connections. It will be appreciated that a similar variation could be applied to any of FIGS. 5a to 5f.

FIG. 5c shows the steps for a third case example comprising a three layer network having a WAS at the highest level (L2), a laptop at level 1, an NFC phone and a PDA at the lowest level (L0). Steps S100 to S208 are the same as FIG. 5b and thus the same number is used. In step S310, the NFC phone controller (NPISC) is unable to connect to a lower level device (e.g. smart card) so the NFC returns only its own result to the laptop.

The laptop policy permits authentication with two lower layer devices. So at Step S312 the laptop's NPISC attempts to establish (or checks if already establish) a proximity link with the PDA. If the link is successful, then service authentication is completed between the laptop and PDA, providing a result based on the PDA credentials (step S316). The laptop uses all or a sub-set of its own credentials and the results from the NFC Phone and PDA to successfully authenticate with the WAS (step S318). The laptop has three proximity and security connections and the NFC phone, PDA and WAS each have one proximity and security connection.

Steps S112 and S114 are the same as FIG. 5a. In this case, the laptop regularly polls the proximity links with the WAS, PDA and NFC (step S326). The NFC phone and PDA may also poll the links (steps S318, S320). Action may be taken by any or all of the devices if any links are lost (steps S120, S122, S124 and S324).

FIG. 5d shows the steps for a fourth case example comprising a three layer network having a WAS at the highest level (L2), a laptop at level 1, a PDA and a smart card at the lowest level (L0). Steps S100 to S108 are the same as FIG. 5a and thus the same number is used. However, at step S106, the laptop controller determines that the policy will not permit service access with connectivity to only one lower layer device. So at step S410, the laptop's NPISC attempts to establish (or checks if already established) a proximity link with the smart card. If the proximity link is successful then service authentication is completed between the laptop and smart card, providing a result based on the smart card credentials (step S412). At step S414, the laptop uses all or a sub-set of its own credentials and the results from the PDA and smart card to successfully authenticate with the WAS. The laptop has three proximity and security connections and the PDA, smart card and WAS each have one proximity and security connection.

Steps S112 and S114 are the same as FIG. 5a. In this case, the laptop regularly polls the proximity links with the WAS, PDA and smart card (step S418). The smart card and PDA may also poll the links (steps S420, S422). Action may be taken by any or all of the devices if any links are lost (steps S120, S122, S426 and S424).

FIG. 5e shows the steps for a fifth case example comprising a three layer network having a WAS or CAS at the highest level (L2), a NFC phone at level 1, a PDA or a smart card at the lowest level (L0). The first step (S500) is for the NFC phone controller to determine whether or not there is an established proximity connection with the WAS (or CAS). This could be done automatically by bringing the laptop controller within the predetermined connection range of the WAS or by user interaction once the two devices are within connection range. The second step is for a service supported by the WA to be offered to a user (Step S501). The user wishes to access a service offered via the WAS and a request is received at the NFC phone (step S502). This requires authentication to establish a security connection.

At the next step (step S504), the NFC phone controller (NPISC) checks the access policy to the service. The NFC phone controller determines that access to the service requires authentication to establish a security connection between the two devices. Furthermore, the access policy (in conjunction with the service information) states that an authentication result based on only the NFC phone's credentials alone is not sufficient and that at least one proximity connection is required to a node in a lower level peer group. Accordingly, at the next step S506, the NFC phone's NPISC attempts to establish (or checks if already established) a proximity link with the smartcard (or the PDA).

As shown at step S508, if the proximity link is successfully established then a security connection (i.e. service authentication) is completed between the smartcard and NFC phone. Then the smartcard credentials are provided to the laptop. As shown at step S510, the NFC phone uses all or a sub-set of its own credentials and the result (i.e. credentials) from the smartcard to successfully authenticate with the WAS (or CAS).

The NFC phone then has two proximity and security connections and the smart card (or PDA) and WAS each have one proximity and security connection. The user has access to the service (step S512) while the existence of the proximity links is regularly polled (S514, S516, S518). If a proximity link is lost an action is taken based on the policies of any or all of the controllers (S520, S522, S524). This can range from do nothing, wait, tear down session, try to re-establish etc. At the end of a successful session the connections will be torn down.

FIG. 5f shows the steps for a sixth case example comprising a two layer network having a NFC phone at the highest level (L1) (herein also referred to as layer one) and a PDA and a smart card at the lowest level (L0) (herein also referred to as layer two). The first step (S600) is for the NFC phone to offer a service to a user (Step S600). This service is hosted on the NFC phone and may be running on a different device (or may be running on the same NFC phone). The user wishes to access the service and a request is received at the NFC phone (step S602). This requires authentication to establish a security connection. If the service is also hosted on the same NFC phone, the phone may also be associated with another layer.

At the next step (step S604), the NFC phone controller (NPISC) checks the access policy to the service. The access policy (in conjunction with the service information) states that an authentication result based on only the NFC phone's credentials alone is not sufficient and that at least two proximity connection is required to a node in a lower level peer group. Accordingly, at the next step S606, the NFC phone's NPISC attempts to establish (or checks if already established) a proximity link with the PDA.

As shown at step S608, if the proximity link is successfully established then a security connection (i.e. service authentication) is completed between the PDA and NFC phone. Then the PDA credentials are provided to the NFC phone. As shown at step S610, NFC phone's NPISC attempts to establish (or checks if already established) a proximity link with the smartcard. It will be appreciated that steps S606 and S610 may be carried out simultaneously. As shown at step S612, if the proximity link is successfully established then a security connection (i.e. service authentication) is completed between the smartcard and NFC phone. Then the smartcard credentials are provided to the laptop. As shown at step S613, the NFC phone uses all or a sub-set of its own credentials and the results (i.e. credentials) from the smartcard and PDA to successfully authenticate with the service.

The NFC phone then has two proximity and security connections and the smart card and PDA each have one proximity and security connection. The user has access to the service while the existence of the proximity links is regularly polled (S614, S616, S618). If a proximity link is lost an action is taken based on the policies of any or all of the controllers (S620, S622, S624). This can range from do nothing, wait, tear down session, try to re-establish etc. At the end of a successful session the connections will be torn down.

No doubt many other effective alternatives will occur to the skilled person. It will be understood that the invention is not limited to the described embodiments and encompasses modifications apparent to those skilled in the art lying within the spirit and scope of the claims appended hereto.

1. A security controller for controlling at least one of a plurality of interconnectable devices, the security controller comprising:
an event input to receive event data;
an action output to output action data;
a processor coupled to said event input to receive said event data,
wherein said processor is connected to a state data store comprising state data indicating a status of a first device in said computing system, said state data comprising a proximity status of said first device relative to at least one other device in said computing system and a security status of said first device relative to at least one other device in said computing system; and
wherein said processor is connected to a policy data store comprising a policy determining the required proximity status and security status of said first device, wherein said required proximity status defines a proximity connection requirement between said first device and at least one other device and wherein said required security status defines a security connection requirement between said first device and at least one other device,
wherein said processor is configured to
read said event data, state data and said policy;
determine whether said proximity status of said first device meets the required proximity status defined in said policy;
determine whether said security status of said first device meets the required security status defined in said policy and
output action data via said action output if both said determining steps are complied with.

2. A security controller as claimed in claim 1, wherein said policy data store, said state data store and said security controller are integrated in said first device.

3. A security controller as claimed in claim 1, wherein said proximity connection requirement comprises a physical connection requirement between said first device and at least one other device.

4. A security controller as claimed in claim 1, wherein said proximity connection requirement comprises a wireless connection requirement between said first device and at least one other device; said wireless connection enabling communication between said first device and said at least one other device, preferably wherein said proximity connection requirement defines one or more of a minimum wireless signal strength or maximum distance between said first device and said at least one other device.

5. (canceled)

6. A security controller as claimed in claim 1:
said processor is configured to output action data via said action output, said action data initiating said security connection requirement between said first device and said at least one device to be established if said processor determines said proximity connection requirement but not said security connection requirement is met; and/or
said security connection requirement comprises establishing an authenticated connection between said first device and at least one other device, preferably wherein said processor is connected to at least one credential data store comprising security credentials for one or more of said plurality of devices, wherein said security credentials are used to establish authentication connections between devices.

7. A security controller as claimed in claim 1, wherein said processor is configured to output action data to update said state data responsive to said event input.

8. (canceled)

9. (canceled)

10. A security controller as claimed in claim 1, wherein said proximity connection requirement is between said first device and a second device and said security connection requirement is also between said first device and said second device.

11. A security controller as claimed in claim 1, wherein:
said action data comprises data enabling access to a service; and/or
said action data comprises data disabling access to a service;
preferably wherein said service is hosted remotely to said first device and said at least one other device.

12. (canceled)

13. (canceled)

14. A device comprising a security controller as claimed in claim 1, wherein said device is selected from the group consisting of a computer, laptop, mobile phone, PDA or similar personal electronic device.

15. A computing system comprising a plurality of interconnectable devices wherein at least one device comprises a security controller comprising:
an event input to receive event data;
an action output to output action data;
a processor coupled to said event input to receive said event data,
wherein said processor is connected to a state data store comprising state data indicating a status of a first device in said computing system, said state data comprising a proximity status of said first device relative to at least one other device in said computing system and a security status of said first device relative to at least one other device in said computing system; and
wherein said processor is connected to a policy data store comprising a policy determining the required proximity status and security status of said first device, wherein said required proximity status defines a proximity connection requirement between said first device and at least one other device and wherein said required security status defines a security connection requirement between said first device and at least one other device,
wherein said processor is configured to
read said event data, state data and said policy;
determine whether said proximity status of said first device meets the required proximity status defined in said policy;
determine whether said security status of said first device meets the required security status defined in said policy and
output action data via said action output if both said determining steps are complied with.

16. A computing system as set out in claim 15 comprising:
a first device comprising said security controller;
a second device hosting a service which is accessible from said first device, and
a third device,
wherein said policy accessed by said security controller defines a proximity connection requirement and a security connection requirement between said first device and said second device and a proximity connection requirement and a security connection requirement between said first device and said third device and
wherein said processor is configured to
determine whether said proximity status of said first device satisfies the proximity connection requirement with both said second and said third devices;
determine whether said security status of said first device satisfies the security connection requirement with both said second and said third devices and
output action data via said action output, said action data enabling access to said service if both said determining steps are complied with.

17. A computing system as claimed in claim 16, wherein said processor is configured to:
output action data via said action output, said action data initiating said security connection requirement between said first device and said third device to be established if said processor determines said proximity status but not said security status is met, and preferably to:
output action data via said action output, said action data enabling said security connection requirement between said first device and said second device to be established
if said processor determines said proximity status but not said security status between said first and second devices is met and
if said processor determines said proximity and security status of said first and third devices is met.

18. (canceled)

19. A computing system as set out in claim 15, further comprising a fourth device and wherein said third device comprises said security controller,
wherein said policy accessed by said security controller of said third device defines a proximity connection requirement and a security connection requirement between said third device and said fourth device and
wherein said processor of said security controller of said third device is configured to
determine whether said proximity status of said third device satisfies the proximity connection requirement with said fourth device;
determine whether said security status of said third device satisfies the security connection requirement with said fourth device and
output action data via said action output, said action data enabling said security connection requirement between said first device and said third device to be established if said processor determines both said determining steps are met.

20. A computing system as set out in claim 15, wherein said plurality of interconnected devices are arranged into a layered hierarchy, and wherein each of said plurality of interconnectable devices are assignable to one of said layers.

21. A computing system as claimed in claim 20, wherein in a first layer a layer one interconnectable device is capable of accessing a said service;
and wherein in a second layer a layer two interconnectable device is capable of satisfying a proximity connection requirement and a security connection requirement to said layer one interconnectable device to access said service.

22. A computing system as claimed in claim 21, wherein in a third layer a layer three interconnected device is capable of hosting a said service for said first interconnected device, preferably wherein said service is hosted by said layer one interconnectable device.

23. (canceled)

24. A computing system as claimed in claim 20, wherein one or more of said interconnectable devices is assignable to one or more of said layers.

25. A computing system as claimed in claim 24, wherein said assignment of said one or more interconnectable devices to one or more of said layers is dependent on context credentials of said one or more interconnectable devices, said context credentials comprising one or more of capabilities of said device or context of said device, preferably wherein said policy specifies a layer requirement for said one or more of said interconnectable devices.

26. (canceled)

27. A method of controlling access to a service on a first device in a computing system, the computing system comprising a plurality of interconnectable devices, the method comprising:
reading an access policy for said service in said computing system, said access policy comprising proximity credentials and security credentials for enabling access to said service on said first device,
wherein said proximity credentials define a required proximity status between said first device and at least one other device to enable access to said service on said first device, and
wherein said security credentials define a required security status between said first device and at least one other device;
determining whether said proximity status of said first device complies with said proximity credentials;
determining whether said security status of said first device complies with said security credentials; and
enabling access to said service if both of said determining steps are complied with.

28. A method as claimed in claim 27, wherein said service is hosted on a second device which is accessible from said first device, preferably wherein said proximity credentials defining a required proximity status between said first device and at least one other device define a required proximity status between said first device and a third device.

29. (canceled)

30. (canceled)
